(19) United States
(12) Patent Application Publication
(10) Pub. No.: US 2003/0069788 A1
(43) Pub. Date: Apr. 10, 2003

(54) System and method of advertisement of internet

(76) Inventor: Ki-Hyoung Han, Incheon (KR)

Correspondence Address: STAAS & HALSEY LLP, 700 11TH STREET, NW, SUITE 500, WASHINGTON, DC, 20001, US

(21) Appl. No.: 09/936,658

(22) PCT Filed: Jan. 18, 2001
(86) PCT No.: PCT/KR01/00079

(30) Foreign Application Priority Data
Jan. 26, 2000 (KR) 2000-3549
Jan. 10, 2001 (KR) 2001-1235

(51) Int. Cl. G06F 17/60

(52) U.S. Cl. 705/14

(57) ABSTRACT

The present invention relates to internet advertisement technique and a business model thereof for the purposes of providing the user with ultra-high speed exclusive lines for internet only free or at low price, enabling the user to utilize a web browser having the motion picture advertising window in the icon tool collection box, multi-casting custom-made advertisements suitable for the tendency of users by accessing in real time to said motion picture advertising window so that it efficiently maximizes the effect of advertisement without causing any inconvenience to the user on web-surfing.

Additionally, when the user on web-surfing creates any click event by clicking a specific motion picture advertising window by means of the web browser, the click event server according to the present invention can provide the specification for goods and/or HTML document for EC business to effect the convenience of easily and directly performing EC business for the user.

Moreover, the present invention suggest a new profit model, particularly, for users who have and use the ultra-high speed lines for internet only, that the web browser having the motion picture advertising window pays the electronic money in proportion to the time to download and use the web browser and leads to use the money on internet for EC business.

### FIELD OF THE INVENTION

The present invention relates to a web browser having a motion picture window and a method using it, and more particularly, a system technique for multi-casting the ordered advertisements suitable for taste of consumer in real time by installing a motion picture window on an icon tool collection box included in the web browser. The present invention also relates to a business model between internet user and advertiser and/or system operator all of them utilizing the said web browser.

### BACKGROUND OF THE INVENTION

Advertisement techniques through internet are continuously advanced in many fields and approached from different sides accompanying rapid increase of internet user numbers. Contrary to known advertisements by way of advertising media such as radio, TV or cable TV, advertisement on internet has a variety of advantages that it is capable of one-to-one announcement suited to taste of consumer, providing consumers with information by securing distribution network for advertisement itself and determining its effect.

Advertisement techniques on internet are known such as banner type or pop-up type advertisement or transmission technique, for example, internet ads are disclosed in U.S. Pat. No. 5,740,549 which is incorporated herein by reference of prior arts.

However, banner technique adopts the manner that-allocates bar space to a section of special web page provided by any web browser to display text or image mode advertisements to user on web surfing.

Pop-up ad of prior art is a technique to create a new advertising window at the stage of down-loading web pages to be highlighted on the display screen of user's PC so that advertising impact is expected by self-exposure manner. But, the banner advertisement according to the above-cited prior arts has troubles not to provide animation or sound effects and simply rely on the web site concerned.

Furthermore, since the banner advertisement of the prior arts occupies at least part of the user's window space at web surfing it causes the user an inconvenience or to hate the banner advertisement. Alternatively, for the case of known pop-up ad, it is uncertain if the ad is exposed to clients and the advertising window regardless of users wishes is created and/or projected on the display screen of user's PC so that it is strongly possible to recognize the protruded pop-up advertising window frame as an obstacle.

Moreover, since the web page of user on web-surfing is blocked by the protruded pop-up advertising window the effect of friendly advertisement to the user can not be expected.

### SUMMARY OF THE INVENTION

It is an object of the present invention to a profitable advertisement model on internet to efficiently provide any advertisement suitable for each of the internet users, that is, netizens and to maximize the effect of advertisement for advertisers.

In addition to the above first object, another object of the present invention is to provide a web browser for motion picture ad to present the user with an advertising window in tool box of the web browser and an advertising method employing the said web browser.

Furthermore, it is another object of the present invention to provide an internet advertisement method and system without the advertising window inconveniently released to the user on web-surfing.

Yet, another object of the present invention is to provide an internet advertisement method and system to send the custom-made advertisements suited to the individual tendency and/or taste of the netizens through the motion picture advertising window in the web browser.

In order to accomplish the above-identified objects, the present invention provides an improved advertisement system on internet which consists of a database for user information, an advertising server, another database for statistical analysis, a click event web server including an index database for event pages, client computers and a network to link them together wherein the client computer drives a web browser having a motion picture advertising window within the tool collection box area, is characterized in that the above system comprises a first process module for user's information to process the login of user or to provide and treat the information of user into the above user information database and/or statistical analysis database for advertisement; a second process module for motion picture advertisement to receive a multi-casting motion picture ad transmitted by the advertising server in real time and displaying it on the said advertising window; a third process module for motion picture click event registering the click event of said statistical analysis database and requiring the said click event web server to transmit event web pages when a user of the client computer clicks the advertising window frame; and a fourth process module for web document to display the web document transmitted by the above click event web server or other external web server through a window frame of the said web browser.

In accordance with another aspect of the present invention, provided is an improved method of advertisement on internet to send motion picture advertisements to the client computer through the network by the system operator to control any local advertising server and/or the central click event web server, comprising the steps of:

(a) performing a web browser having a motion picture advertising window in its tool collection box within said client computer to identify the login of a user accessed to the user information database of said local database server;

(b) calculating suitability of the mode selected according to the user information by said user identified by his(her) login in step (a);

(c) accessing motion picture advertisement materials included in a category having the suitability calculated in step (b) more than a selected reference value, from the advertisement media database of said local database server; and

(d) transmitting the motion picture advertisement materials accessed in step (c) in real time multi-casting manner displaying them on the advertising window of the web browser in the client computer running by the user.

### BRIEF DESCRIPTION OF THE DRAWINGS

FIG. 1 illustrates a configuration of an internet advertisement solution according to the present invention;

FIG. 2 illustrates the web browser including a motion picture advertising window according to the present invention;

FIG. 3 is a schematic diagram showing the workflow of advertisement method on internet according to the present invention;

FIG. 4 illustrates a preferred embodiment of the profitable model by the system operator to provide a web browser including a motion picture advertising window according to the present invention;

FIG. 5 illustrates another preferred embodiment of the profitable model, by the system operator to provide a web browser A to 2G illustrate, in sectional views, a method for forming a field oxide film according to the present invention.

### DETAILED DESCRIPTION OF PREFERRED EMBODIMENTS

The present invention will be described in more detail with regard to the accompanying drawings.

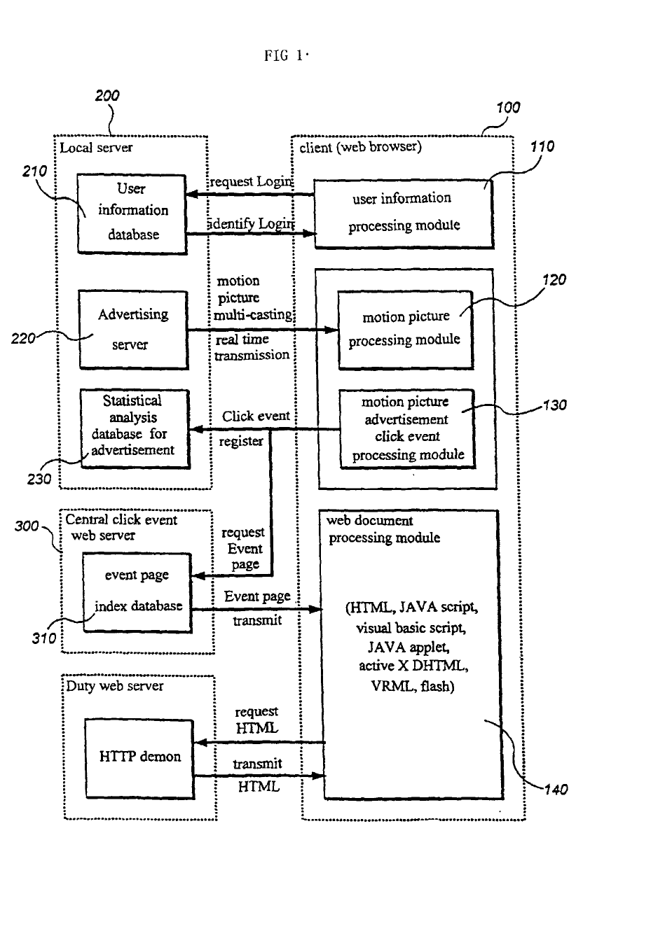

FIG. 1 is a schematic diagram illustrating the configuration of an internet advertisement solution according to the present invention. Referring to FIG. 1, it shows a client 100 to run the web browser having a motion picture advertising window, a user information database 210, an advertising server 220, a local server including the statistical analysis database 230 for advertisement, a central click event web server 300 having the event page indexing database 310.

The web browser run in the client 100 has a tool collection box provided with a motion picture advertising window, and further includes a user information processing module 110, a motion picture advertisement processing module 120, a click event processing module 130 for said motion picture advertisement and a web document processing module 140. The module 110 may be a process module to provide and treat user informations into said databases 210 and 230.

The processing module (for motion picture advertisement) 120 may be preferably a process module to (dis)play ASF formatted motion picture ads which were multi-casted in real time, on the (motion picture) advertising window of the web browser according to the present invention. The click event processing module 130 for motion picture advertisement may be a process module to register any click event within the statistical analysis database 230 and request the central click event web server 300 the corresponding event web page when said click event is generated, in connection with the motion picture advertisement materials displayed on the motion picture advertising window.

As a preferred embodiment of the present invention, the processing module 120 can be integrated into a process module unit by combining it with said click event processing module 130. The web document processing module 140 shown in FIG. 1 is a process module to illustrate a HTML transmitted by HTTP.

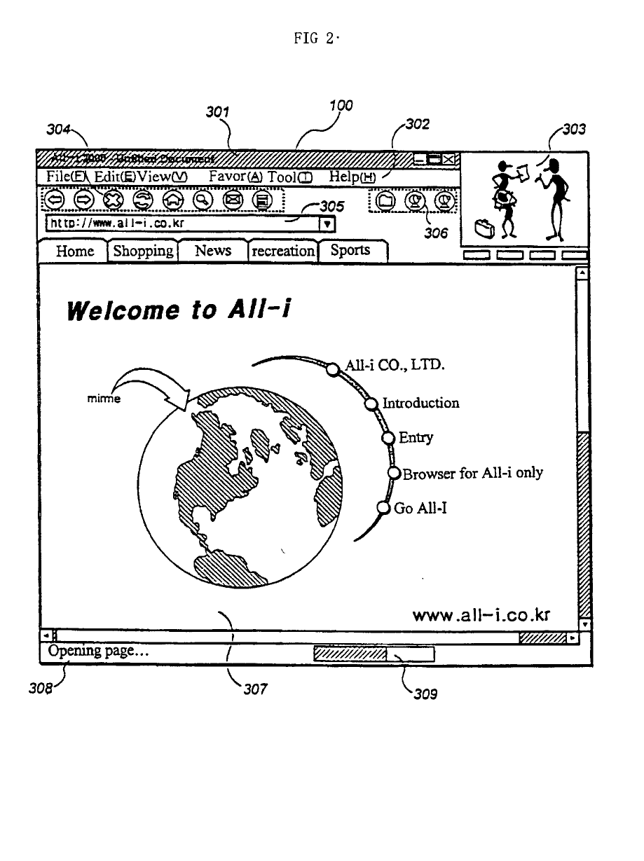

FIG. 2 shows a web browser having the motion picture advertising window of the present invention. Referring to FIG. 2, the web browser is characterized in that it includes the motion picture advertising window 303 in an area of the tool collection box space. Said window 303 has an advantage of displaying only the motion picture on the window 303 without interrupting user on web-surfing the real time motion picture provided by the advertiser server 220.

By the motion picture displayed on the advertising window according to the present invention, good sound compared with CD level more than 16 bits and picture corresponding to MPEG level within the bandwidth of at least 100 kbps can be represented. Also, the advertising window effects to embody the sound and animation in real time by employing flash technique. Alternatively, the advertising window can receive the motion picture by the advertiser server and display it by push mode.

Returning to FIG. 2, since the web browser includes a window 303 for motion picture advertisement in the tool collection box, it is advantageous not to infringe on the space of the window frame 307 represented by the user on web-surfing compared to prior art.

The inventive web browser further comprises, in addition to the motion picture advertising window 303, title indicating area 301, menu 302, tool box 304, address (URL) input window 305, favorites, direct-channel collection 306 such as information channel or telecommunication channel, web browser window 307, progress text indication 308 and progress state indication 309.

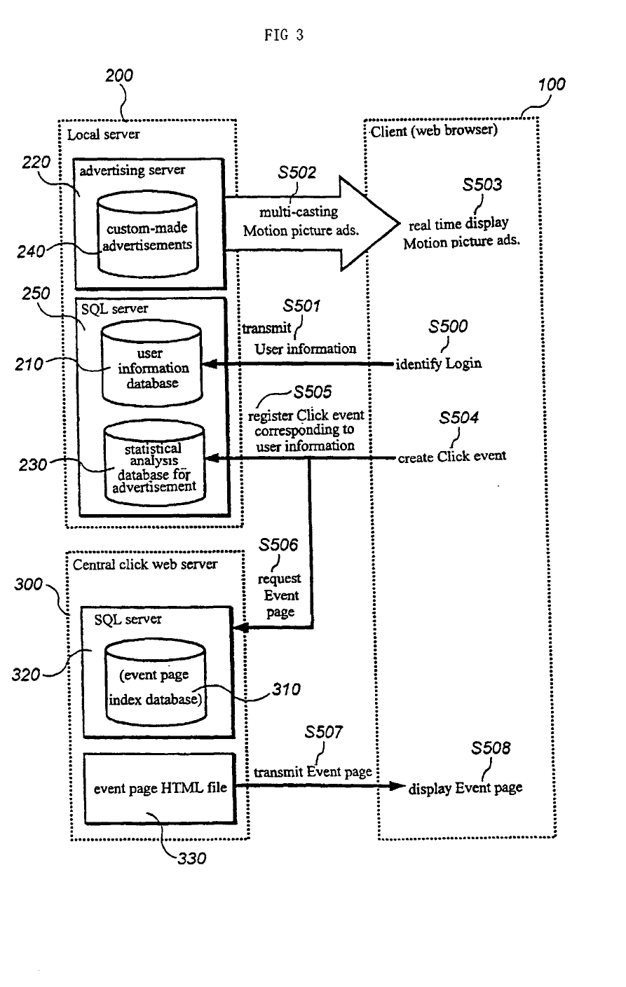

FIG. 3 illustrates a workflow of the advertisement method on internet according to the present invention, The inventive web browser can be sent from the system operator to provide internet ads solutions according to the present invention and be installed within the client computer. The system operator who provides the specified internet ads solutions of the present invention allows the user to utilize the web browser having motion picture advertising window and provides high-speed and large capability exclusive lines.

The web browser having the inventive motion picture advertising window on a part of the tool collection box may be downloaded to users, and the user downloaded with the web browser is given the electronic money (for example, bonus e-money such as “M.COIN”). In this case, the ad server operator or system businessman who distributes the web browser allots the advertising revenue by advertisers for the installation and/or operation costs of the exclusive line, and permits the internet user to use the contents service and/or EC (Electronic Commerce) in the web site of said system businessman by means of the given e-money(M.COIN).

Referring in FIG. 3, in case of where the web browser 100 installed in the client computer is worked, the user accesses to the user information database 210 managed by SQL server 250 of any local server 200 and waits the identification of his(or her) login by the server (step S500). In this step, the server 250 receives the information regarding the user connected to the database 210 and makes a calculation of the suitability to select any specific mode depending on the users information.

The calculation of suitability according to the present invention means, with regard to the motion picture advertisement displayed on the advertising window of the web browser 100, the procedure to classify categories of advertisement materials to be transmitted in order to send custom-made ads suitable for taste or tendency of users. The calculation method for suitability is practiced by employing personal information of user members, including age, sex, occupation, educational background, hobby and web use history, to give each of them a score to identify tendencies of the members and send the appropriate ads materials.

Now, the advertising method using internet according to the present invention, is characterized in that it can multi-cast custom-made ads materials in real time to the motion picture advertising window 300 of the client web browser 100 by creating said ads materials as the result of the calculation of suitability described above from the database 240 managed by the advertising server 220 of any local server 200 (step S502).

Consequently, the user employs and web-surfs the inventive web browser in the client computer and, simultaneously, accomplishes(or practices) the (dis)play of custom-made motion picture ads materials in the advertising window without preventing the web-surfing work. Multi-media contents including internet music broadcast or internet broadcast may be also preferably transmitted and played, in addition to the advertising window according to the present invention as disclosed above.

In particular, in-case of where the client and/or user who utilizes the web browser having the motion picture advertising window of the present invention clicks the motion picture ads materials under multi-casting process during watching TV, the central click event server can embody the bidirectional broadcast on internet to provide multi-media motion pictures by running multi-media broadcast channel application program independent of the web browser at clicking ads.

Furthermore, the web browser having the advertising window of the present invention makes the window showing web pages by means of TAP mode to be embodied to the web browser in a specified form so that can eliminate the prior trouble of known web browsers to make the user to close all pop-up window frames one by one.

In case of where the user web-surfs with the web browser of the present invention, he(or she) can click the motion picture advertising window displaying the ads materials drawing his(or her) intention (step S503). As disclosed above, when a click event is produced, a click event corresponding to the user information is registered on the statistical analysis database 230 by any local server 200 (step S504).

The local server 200 according to the present invention may be preferably equipped by areas and the statistical analysis database 230 for advertisement can provide the advertiser the statistical data for the user access frequency to ads materials supplied by the advertiser. Continuously, as the result of creating click event (step S504), the event page index database managed by the SQL server 320 contained in the central click event web server 300 is given the request for any event pages (step S505). Therefore, the central click web server of the present invention transmits the event page HTML document 330 requested toward the concerned client (step S506).

The inventive event page HTML document can provide goods information relating to ads materials displayed at clicking or conditions and/or states for achieve EC.

Finally, the web browser 100 of the client displays the event page transmitted from the central web server 300 on a new window created so that the user can directly obtain any goods or EC information without a bother to connect the URL address of advertiser.

The web browser having the motion picture advertising window according to the present invention enables a plurality of initial web pages for films to serve contents such as PORTAL, cyber stock exchange or custom-made information to be set up so that the user can create the original set up web page only by working the web browser without connecting to all of the web sites to get the contents required separately.

Moreover, the web browser having the motion picture advertising window of the present invention in a part of the tool collection box space supplies any computer game rooms (so called ‘PC room’) ultra-high speed exclusive lines for internet free or at a low price. Consequently, it is possible to build a network as a multi-plaza and distribution center, which maximizes the profits such as motion picture ads profit, motion picture production, contents and EC benefits, based on large member of internet users.

Particularly, if at least 20,000 PC rooms spread out all over the country are supplied with ultra-high speed internet lines and the present inventive web browser having the motion picture advertising window installed on the internet lines, it will be understood that it makes a large profit, including motion picture advertising and production profits and fees with contents and EC business.

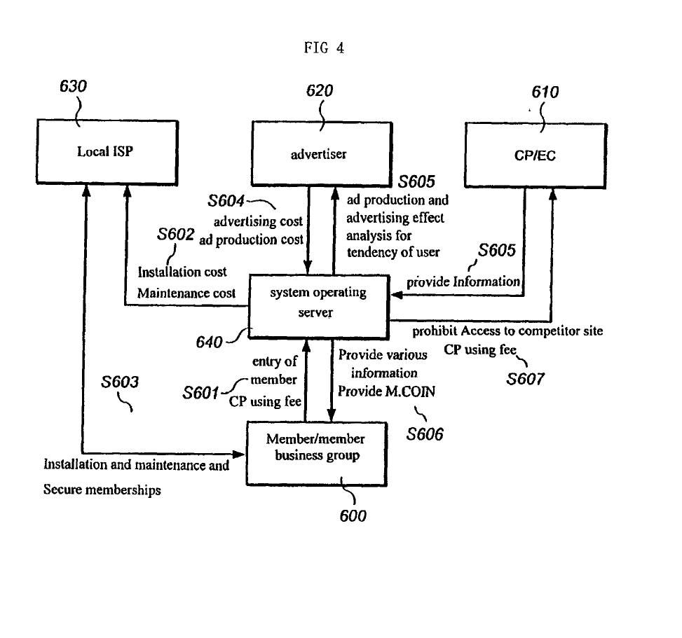

FIG. 4 shows a preferred embodiment of the profit model of the system operator to provide a web browser having the motion picture advertising window according to the present invention. Referring to FIG. 4, the system operator 640 collects members among internet users 600 (step S601), pays the costs of installation and maintenance to local ISP(Internet Service Provider) (step S602) and installs ultra-high exclusive lines for internet to internet users free of charge (step S603).

For this case, individual members or member business groups 600 may be ordinary users and/or PC room owners. While the system operator 640 is given the payment of advertising expense and production costs from the advertiser 620 (step S604) in compensation for providing ads production and advertising effect data, analytical data for tendency of users, etc. (step S605). Another system operator as a distributor of the web browser according to the present invention can serve the members or member business groups 600 with various information and/or electronic money(M.COIN) (step S606). As a preferred embodiment of the present invention, the web browser may be designed to restrict the access to competitor sites with regard to the supply of contents or EC business (step S607).

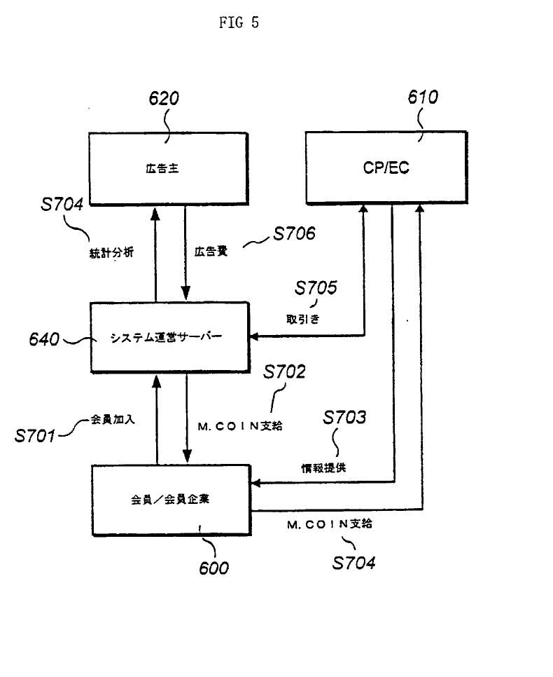

FIG. 5 illustrates another example of the profit model of the system operator to provide a web browser including the motion picture advertising window according to the present invention. Referring to FIG. 5, for users who have and use the ultra-high speed lines for internet only 600 the system operator connects to the system operation server and completes the accept of memberships while, in case of users who use the web browser of the present invention, the system operator can pay e-money(M.COIN) for using the web browser.

In this state, the e-money 600 given to members 600 can be increased in proportion to the amount of advertisement the members saw and the members 600 can obtain contents by using M.COIN (steps S703, S704) or join EC and enjoy shopping on internet (step S705). The system operator 640 is given the costs of advertisement from the advertiser (step S706) and supply the statistical analysis service for custom-made ads for each of users (step S707).

Although the invention has be illustrated and described more or less wider with respect to exemplary embodiments thereof to understand the features and/or technical advantages of the present invention. Other additional features and/or advantages set forth in the append claims will be described in detail below.

It should be understood by those skilled in the art that foregoing concepts and specific embodiments of the present invention are the basis for various other changes and/or alterations to accomplish the purpose of the invention and can be embodied at once.

Also, it should be understood by those skilled in the art that the concepts and embodiments of the present invention can be changed and/or altered to achieve the same purpose of the invention without departing from the spirit and scope of the present invention. Therefore, the present invention should not be understood as limited to the specific embodiments set forth above but to includes all possible variations and changes which can be embodied within a scope encompassed and equivalents thereof, with respect to the feature set forth in the claims appended thereto.

### EFFECT OF THE INVENTION

As compared with conventional advertising art, the present invention can maximize the effect of advertisement without causing the user on web-surfing any bother by installing a motion picture advertising window in the icon collection box of a web browser and accessing in real time to perform the real time multi-casting the custom-made ads suitable for the tendency of users.

Moreover, in case of where a click event is created on the motion picture according to the present invention, the present invention can supply the specification for goods and/or HTML documents, contrary to prior art which connects to the URL address of the advertiser, so that it enables the user to easily purchase goods through EC system.

What is claimed is:

1. A system of advertisement on internet comprising a user information database, an advertising server, a statistical analysis database for advertisement, a click event web server including an event page index database, client's servers and a network to link them together in which the client computer drives a web browser having a motion picture advertising window within the tool collection box area, wherein the system comprises a first process module for user's information to process the login of user or to provide and treat the information of user into the above user information database and/or statistical analysis database for advertisement; a second process module for motion picture advertisement to receive a multi-casting motion picture ad transmitted by the advertising server in real time and displaying it on the said advertising window; a third process module for motion picture click event registering the click event of said statistical analysis database and requiring the said click event web server to transmit event web pages when a user of the client computer clicks the advertising window frame; and a fourth process module for web document to display the web document transmitted by the above click event web server or other external web server through a window frame of the said web browser.

2. The system as claimed in claim 1, wherein any one selected from the user information database, the statistical analysis database for advertisement or the advertising sever or the combination thereof is managed and/or controlled by any corresponding local server.

3. The system as claimed in claim 1, wherein the click event web server is managed and/or controlled by a central server.

4. The system as claimed in claim 1, wherein said event web pages transmitted from the click event web server include the purchase information for goods displayed on the advertisement shown at the time of creating said click event.

5. The system as claimed in claim 1, wherein said event web pages transmitted from the click event web server include the web page for EC business for goods displayed on the advertisement shown at the time of creating said click event.

6. The system as claimed in claim 1, wherein the motion picture advertising window practices at least any one selected from motion picture ads materials, internet broadcast or internet music broadcast in real time.

7. The system as claimed in claim 1, wherein said event web pages transmitted from the click event web server include multi-channel internet broadcast.

8. The system as claimed in claim 1, wherein the web browser is embodied in TAP mode when a plurality of web pages are displayed.

9. The system as claimed in claim 1, wherein the user of said client computer is given the web browser having said motion picture advertising window, practices web-browsing by employing said web browser, is capable of seeing said motion picture ads materials and, simultaneously, permitted to use the exclusive line for said network only from the provider of said web browser.

10. The system as claimed in claim 1, wherein the user of said client computer is given the web browser having said motion picture advertising window, practices web-browsing by employing said web browser, is capable of seeing said motion picture ads materials and, simultaneously, receives the electronic money in proportion to the time to use said web browser from the provider of said web browser.

11. The system as claimed in claim 9 or 10, wherein said client computer has a plurality of computers and is the computer of PC room to serve ordinary individuals enjoying internet with said plural computers.

12. A method of advertisement on internet to send motion picture advertisements to a client computer through the network by any local advertising server and/or a system operator to control the central click event web server, comprising the steps of:
(a) performing a web browser having a motion picture advertising window in its tool collection box within said client computer to identify the login of a user accessed to the user information database of a local database server;
(b) calculating suitability of the mode selected according to the user information by said user identified by his(her) login in step (a);
(c) accessing motion picture advertisement materials included in a category having the suitability calculated in step (b) more than a selected reference value, from the advertisement media database of said local database server; and
(d) transmitting the motion picture advertisement materials accessed in step (c) in real time multi-casting manner displaying them on the advertising window of the web browser in the client computer running by the user.

13. The method as claimed in claim 12, wherein further includes a step that the user of the client computer is provided with the web browser having said motion picture advertising window in a part of the tool collection box space by said system operator before the practice of said method.

14. The method as claimed in claim 13, wherein further includes a step that the user of the client computer is given an exclusive line for said network only from said system operator.

15. The method as claimed in claim 12, wherein further includes a step that the user of the client computer receives the electronic money in proportion the time to use said web browser having the motion picture advertising window in a part of the tool collection box space.

16. The method as claimed in claim 12, wherein further comprises the steps of;
(e) creating click events by clicking a specific motion picture advertising window on which said motion picture ads materials are (dis)played;
(f) registering said click events on the statistical analysis database installed in the local database server according to the user information at creating said click events;
(g) accessing the event page index database installed in the central web server communicated with said local database server when the click events are created and requesting the corresponding event web page; and
(h) a management server for event page index database within said central web server transmits said event page to the user and displays it on a new window frame.

17. The method as claimed in claim 16, wherein said event page provides goods information for electronic commerce(EC) business and/or circumstance for it.

18. The method as claimed in claim 16, wherein said event page further includes multi-channel internet broadcast page.
